(19) United States
(12) Patent Application Publication
(10) Pub. No.: US 2026/0342008 A1
(43) Pub. Date: Oct. 29, 2026

(54) CONNECTOR ASSEMBLY

(71) Applicants: HYUNDAI MOTOR COMPANY, SEOUL (KR); KIA CORPORATION, SEOUL (KR)

(72) Inventors: Geon Gu Kang, Hwaseong-si (KR); Min Seok Kang, Hwaseong-si (KR); Dong Hyun Kim, Hwaseong-si (KR); Sang Jun Kim, Siheung-si (KR)

(73) Assignees: HYUNDAI MOTOR COMPANY, SEOUL (KR); KIA CORPORATION, SEOUL (KR)

(21) Appl. No.: 19/718,357

(22) Filed: Jun. 24, 2026

(30) Foreign Application Priority Data
Dec. 4, 2025 (KR) 10-2025-0190443

(51) Int. Cl. H01R 13/629; H01R 13/627; H01R 13/641; H01R 24/20; H01R 24/28

(52) U.S. Cl. CPC H01R 13/6295; H01R 13/6273; H01R 13/641; H01R 24/20; H01R 24/28

(57) ABSTRACT

A connector assembly is capable of reducing manufacturing costs by reducing an overall size of a connector. The connector assembly includes a female connector, a male connector coupled to the female connector, and a moving plate seated in the male connector, the moving plate being moved from an initial position to a final position when the female connector is coupled to the male connector and being moved from the final position to the initial position when the female connector is separated from the male connector.

### CROSS REFERENCE TO RELATED APPLICATIONS

The present application claims priority to Korean Patent Application No. 10-2025-0190443, filed on Dec. 4, 2025, the entire contents of which is incorporated herein for all purposes by this reference.

### TECHNICAL FIELD

The present disclosure relates to a connector assembly, and more particularly, to a connector assembly including a moving plate.

### BACKGROUND

Typically, an electrical connector includes a housing in which a terminal to which a wire is connected is mounted, and when a male connector and a female connector are provided as a pair and are coupled to each other, the two connectors are electrically connected to each other.

On the other hand, although an electrical terminal is fixed to the housing through a terminal, the terminal may not be fully inserted into the housing during an assembly process of the connectors, or the terminal may be separated by vibration during use. The above-described defects frequently occur in the field of automobiles that are subject to continuous vibration during operation.

In particular, when the terminal is deformed during the assembly process of the connectors or when a defective deformed terminal causes an assembly error or poor contact of the connectors during the assembly process of the connectors, since a large number of wirings are installed in a vehicle, it is extremely difficult to identify an incompletely coupled connector among the plurality of wirings, and efficiency of repair or correction work is significantly reduced.

In order to overcome the above-described limitations, a terminal position assurance (TPA) for detecting incomplete insertion of a terminal, and a moving plate capable of identifying a coupled state of the TPA are proposed.

However, a general moving plate has a structure in which operating portions are disposed on both sides and an outer edge of the moving plate, the moving plate surrounds a female connector, and in turn, a housing of a male connector surrounds the moving plate. As a result, there is a disadvantage in that an overall size of the connector assembly is relatively increased. Also, there is a disadvantage in that, since the moving plate is caught by an outer portion of the male connector, when the female connector is coupled in a tilted state, incomplete coupling may occur between the moving plate and the female connector, thereby causing interference while coupling overall connectors.

The matters described in this background section are provided to facilitate an understanding of the background of the present disclosure, and may include matters that do not constitute prior art already known to a person having ordinary skill in the art to which the present disclosure pertains.

### SUMMARY

The present disclosure provides a connector assembly capable of reducing manufacturing costs by reducing an overall size of a connector.

The present disclosure also provides a connector assembly capable of easily coupling connectors during a connector assembly process.

An embodiment of the present disclosure provides a connector assembly including a female connector, a male connector coupled to the female connector, and a moving plate seated in the male connector, the moving plate configured to move from a first position to a second position when the female connector is coupled to the male connector and to move from the second position to the first position when the female connector is separated from the male connector.

In an embodiment, the male connector may further include a male housing in which the moving plate is seated, and the female connector may further include a female housing that is brought into contact with the moving plate.

In an embodiment, the moving plate may include an arc-shaped protrusion that is brought into contact with the female housing.

In an embodiment, the male housing may include a vertical extension portion to which the moving plate is coupled at the first position.

In an embodiment, the male housing may include an accommodating portion in which the moving plate is seated at the second position.

In an embodiment, the male housing may include a center extension portion extending from an end of the vertical extension portion.

In an embodiment, the arc-shaped protrusion may include a connection portion extending from a plate base and an arc portion disposed at an end of the connection portion.

In an embodiment, two arc-shaped protrusions may be disposed symmetrically with respect to each other.

In an embodiment, the arc-shaped protrusion may include an inner contact portion and an inner stepped portion, which are brought into contact with the male housing at the first position.

In an embodiment, the moving plate may include a horizontal contact portion that is brought into contact with the female housing.

In an embodiment, the male housing may include an accommodating portion in which the moving plate is seated at the second position.

In an embodiment, the moving plate may include a vertical guide that is brought into contact with a side wall of the accommodating portion.

In an embodiment, the moving plate may include a horizontal contact portion that is brought into contact with the female housing.

In an embodiment, the female housing may include an upper rail configured to press an upper portion of the arc portion, thereby rotating the arc-shaped protrusion.

In an embodiment, the female housing may include a lower rail configured to support a lower portion of the arc portion.

In an embodiment, the male connector may further include a male terminal position assurance (TPA) coupled to the male housing.

In an embodiment, the female connector may further include a female TPA coupled to the female housing.

In an embodiment, the female connector may further include a lever coupled to the female housing.

In an embodiment, the male connector may further include a plurality of male terminals coupled to the male housing.

In an embodiment, the female connector may further include a plurality of female terminals coupled to the female housing.

### BRIEF DESCRIPTION OF THE FIGURES

FIG. 1 is an assembly view illustrating a connector assembly according to an embodiment of the present disclosure.

FIG. 2 is a configuration view illustrating the connector assembly of FIG. 1.

FIG. 3 is a cross-sectional view of FIG. 2.

FIG. 4 is a configuration view illustrating a moving plate of FIG. 1.

FIG. 5 is a cross-sectional view illustrating an initial stage of coupling of the connector assembly of FIG. 2.

FIG. 6 is a cross-sectional view illustrating an intermediate stage of the coupling of the connector assembly of FIG. 2.

FIG. 7 is a cross-sectional view illustrating a final stage of the coupling of the connector assembly of FIG. 2.

FIG. 8 is a cross-sectional view illustrating an initial stage of separation of the connector assembly of FIG. 2.

FIG. 9 is a cross-sectional view illustrating an intermediate stage of the separation of the connector assembly of FIG. 2.

FIG. 10 is a cross-sectional view illustrating a final stage of the separation of the connector assembly of FIG. 2.

### DETAILED DESCRIPTION

Since the present disclosure may have diverse modified embodiments, preferred embodiments are illustrated in the drawings and are described in the detailed description of the disclosure. However, this does not limit the present disclosure within the specific embodiments and it should be understood that the present disclosure covers all the modifications, equivalents, and replacements within the idea and technical scope of the present disclosure.

In this specification, the suffixes “module” and “unit” are used merely for nominal distinction between components and should not be interpreted as implying that the components are physically or chemically separated or that they can be separated.

It will be understood that although the terms of “first” and “second” are used herein to describe various elements, these elements should not be limited by these terms. Terms are only used to distinguish one component from other components.

The term “and/or” is used to include all possible combinations of the listed items. For example, “A and/or B” includes all three cases of “A”, “B”, and “A and B”.

It will also be understood that when an element is referred to as being “‘connected to” or “engaged with” another element, it can be directly connected to the other element, or intervening elements may also be present.

In the following description, the technical terms are used only for explaining a specific exemplary embodiment while not limiting the present disclosure. The terms of a singular form may include plural forms unless referred to the contrary. The meaning of ‘include’ or ‘comprise’ specifies a property, a region, a fixed number, a step, a process, an element and/or a component but does not exclude other properties, regions, fixed numbers, steps, processes, elements and/or components.

Unless terms used in the present disclosure are defined differently, the terms may be construed as meaning known to those skilled in the art. Terms such as terms that are generally used and have been in dictionaries should be construed as having meanings matched with contextual meanings in the art. In this description, unless defined clearly, terms are not ideally, excessively construed as formal meanings.

Hereinafter, embodiments of the present disclosure will be described with reference to drawings.

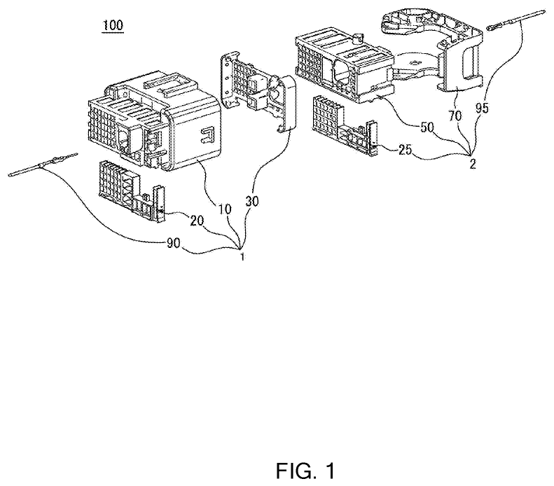

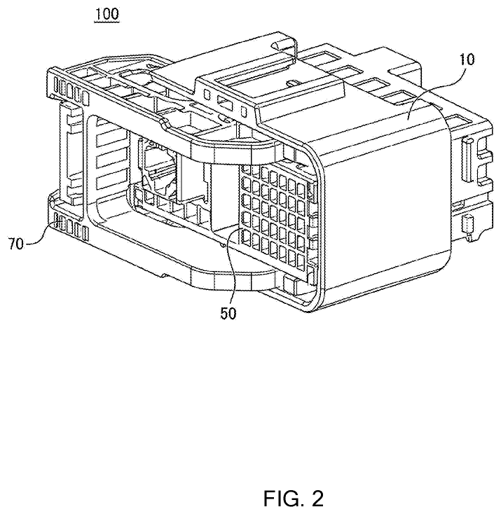

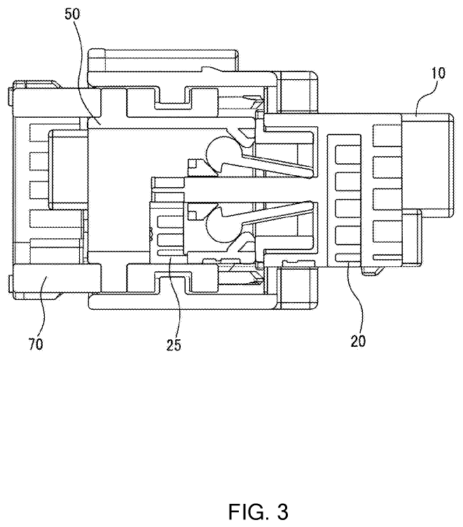

First, FIG. 1 is an assembly view illustrating a connector assembly 100 according to an embodiment of the present disclosure, FIG. 2 is a view illustrating the assembled connector assembly 100, and FIG. 3 is a cross-sectional view of FIG. 2.

The connector assembly 100 may include a male housing 10, a male terminal position assurance (TPA) 20, a moving plate 30, a female housing 50, a female TPA 25, a lever 70, a male terminal 90, and a female terminal 95.

Here, as illustrated in FIGS. 2 and 3, the male terminal 90 is coupled to a side surface of the male housing 10, and the mail housing 10 accommodates an entirety of the moving plate 30, an entirety of the female housing 50, and a portion of the lever 70 coupled to the female housing 50.

The male housing 10 may serve to prevent the male terminals 90 to be coupled from being deformed and block foreign substances from being introduced, and may also serve to support an overall structure. Also, the male housing 10 may have an appropriate strength.

In addition, various structures such as coupling holes and coupling protrusions for coupling with other members may be formed on inner and outer surfaces of the male housing 10.

The male TPA 20 may be coupled to the male housing 10 to serve as a double locking device for preventing incomplete fixing of the male terminals 90 coupled to the male housing 10. Also, structures such as coupling holes and coupling protrusions for coupling with other members may be formed in the male TPA 20.

When the moving plate 30 is seated in the male housing 10 and the female housing 50 is inserted into the male housing 10, the moving plate 30 may move together with the female housing 50, thereby serving to improve coupling reliability of the connector.

As illustrated in FIGS. 2 and 3, the female housing 50 may be inserted into the male housing 10 for coupling, and here, previously inserted moving plate 30 may be moved together with the female housing 50.

The female housing 50 may also have various structures, such as coupling holes and coupling protrusions for coupling with other members, formed on outer and inner surfaces thereof.

The female TPA 25 may also be coupled to the female housing 50 to serve as a double locking device for preventing incomplete fixing of the female terminal 95 coupled to the female housing 50. Also, structures such as coupling holes and coupling protrusions for coupling with other members may be formed in the female TOA 25.

As illustrated in FIG. 2, when the lever 70 is coupled to the female housing 50, a portion of the lever 70 may be inserted into the male housing 10.

The lever 70 may also include various structures, such as coupling holes and coupling protrusions, for coupling with the female housing 50 and the male housing 10.

Since a portion of the lever 70 is disposed outside the male housing 10, the lever 70 may serve as a handle for an operator to couple and separate the connector.

The male terminal 90 and the female terminal 95 may be provided in plurality, and may be respectively coupled to the male housing 10 and the female housing 50.

Coupling holes for accommodating the male terminal 90 and the female terminal 95 may be formed in the male housing 10 and the female housing 50.

Here, a male connector 1 may refer to a component in which the male housing 10, the male terminal position assurance (TPA) 20, the moving plate 30, and the male terminals 90 are coupled.

The moving plate 30 may be seated at an initial position in the male housing 10.

Also, a female connector 2 may refer to a component in which the female housing 50, the female TPA 25, and the female terminal 95 are coupled.

In addition, the moving plate 30 may be seated at the initial position in the male housing 10 before the female connector 2 is coupled to the male housing 10 of the male connector 1.

On the other hand, the connector assembly 100 according to the present disclosure is configured such that the female connector 2 in which the female housing 50 and the lever 70 are coupled is inserted into the interior of the male housing 10 in a state in which the moving plate 30 is seated at the initial position of the male housing 10, and as the inserted female housing 50 gradually moves downward, the moving plate 30 seated at the initial position is separated from the initial position and moves downward together with the female housing 50, thereby being seated at a final position.

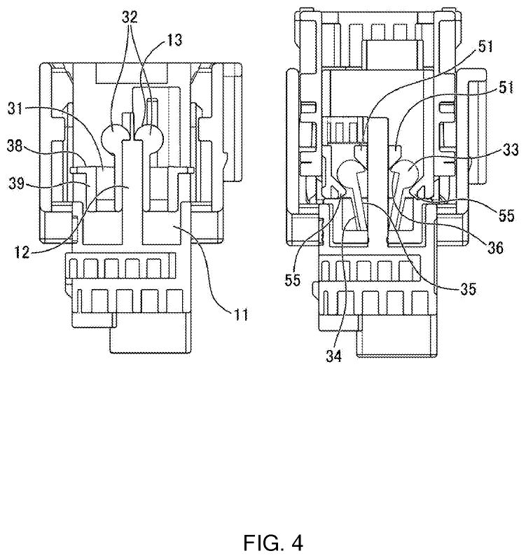

As illustrated in FIGS. 3 and 4, the moving plate 30 may include two arc-shaped protrusions 32 that are spaced a predetermined distance from each other and are symmetrically disposed so that the moving plate 30 is inserted into the male housing 10 and seated at the initial position.

Each of the arc-shaped protrusions 32 may include an arc portion 33 disposed at an upper end thereof and a connection portion 34 connected to the arc portion 33.

One end of the connection portion 34 may be integrated with a plate base 31, and the arc portion 33 may be deformed into a spreading shape by elastic deformation of the connection portion 34.

The arc-shaped protrusion 32 may further include an inner contact portion 35 and an inner stepped portion 36. Since the inner contact portion 35 and the inner stepped portion 36 may be formed to be perpendicular to each other, the inner contact portions 35 and the inner stepped portions 36 of the two arc-shaped protrusions 32 may be implemented in a rectangular shape.

However, the arc portions 33 of the two arc-shaped protrusions 32 may be spaced a predetermined distance from each other in an initial state in which the connection portions 34 are not deformed.

Also, the moving plate 30 may include a horizontal contact portion 38 that is brought into contact with the female housing 50, and may further include a vertical guide 39 guided by an accommodating portion 11 of the male housing 10.

The horizontal contact portion 38 may protrude horizontally from the vertical guide 39 in a horizontal shape and be brought into contact with the female housing 50 being moved. The vertical guide 39 may have a vertical shape to perform a sliding movement while contacting respective side walls of the accommodating portion 11 of the male housing 10.

Also, the male housing 10 may include a vertical extension portion 12 extending vertically from a center thereof for guiding an initial position of the arc-shaped protrusion portion 32 and a center extension portion 13 extending vertically again from an end of the vertical extension portion 12.

Since the vertical extension portion 12 extends vertically from the accommodating portion 11 of the male housing 10, the vertical extension portion 12 may be greater in length than the inner contact portion 35 of the arc-shaped protrusion 32.

Also, a length of an upper end of the vertical extension portion 12 may be greater than a combined length of the inner stepped portions 36 of the two arc-shaped protrusions 32, and the vertical extension portion 12 may have a rectangular outer shape.

In addition, the center extension portion 13 may have a width equal to a distance between the two arc portions 33, and have a rectangular shape.

Accordingly, as illustrated in FIG. 4, when the moving plate 30 is initially coupled to the male housing 10, the two arc-shaped protrusions 32 are in an undeformed state, and each of the inner contact portions 35 and the inner stepped portions 36 is brought into contact with one surface of the vertical extension portion 12. Here, the inner stepped portions 36 may serve as stoppers that restrict downward movement of the moving plate 30.

Also, the center extension portion 12 may be disposed between the inner stepped portions 36.

On the other hand, when the female connector 2 is coupled to the male connector 1, the female housing 50 of the female connector 2 may spread the arc-shaped protrusions 32, thereby separating the moving plate 30 from the initial position to be transported together with the female housing 50.

The arc-shaped protrusions 32 are initially seated on the vertical extension portion 12. Here, the female housing 50 may include two upper rails 51 that press upper portions of the arc portions 33 of the arc-shaped protrusions 32 during downward movement and two lower rails 55 that support lower portions of the arc portions 33 of the arc-shaped protrusions 32, so as to spread the arc-shaped protrusions 32 apart from each other.

Here, the upper rails 51 and the lower rails 55 may be disposed symmetrically with respect to the vertical extension portion 12.

In particular, a distance between the upper rails 51 may have a length sufficient to accommodate the vertical extension portion 12.

Accordingly, when the female housing 50 is moved downward, the vertical extension portion 12 is disposed between the upper rails 51, thereby preventing mutual interference therebetween.

Also, during downward movement, the upper rails 51 may press the arc portions 33 of the arc-shaped protrusions 32, which are vertically disposed, so as to spread the arc-shaped protrusions 32 apart from each other.

In addition, an inclined portion may be formed on one surface of each of the upper rails 51 so that the arc-shaped protrusions 32 are spread apart from each other.

The lower rails 55 may be disposed at positions on both side surfaces of the female housing 50, at which appropriate elasticity is exhibited, and may be formed with an inclination and at positions capable of supporting bottom surfaces of the arc portions 33 of the arc-shaped protrusions 32 that are spread apart from each other by the upper rails 51.

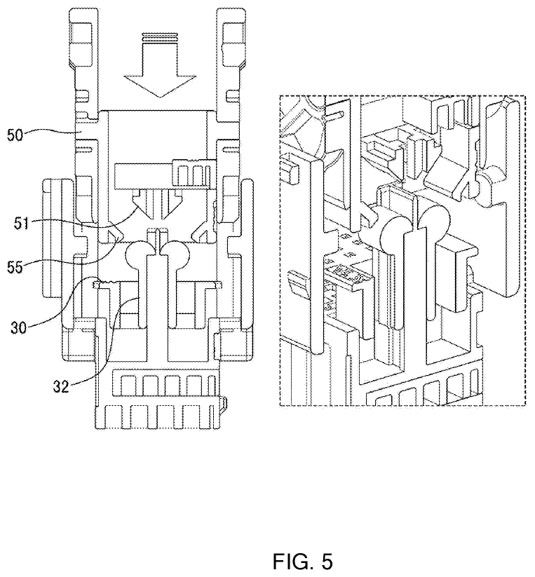

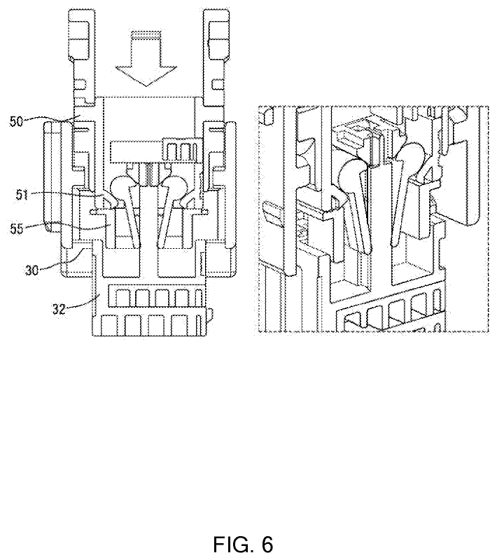

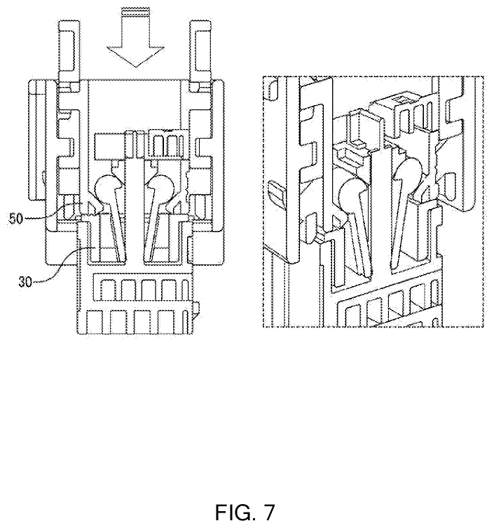

Thus, as illustrated in FIGS. 5 to 7, when the female connector 2 is coupled to the male connector 1, as the female housing 50 is moved in a downward direction, the moving plate 30 may be moved from a state of being seated on the vertical extension portion 12, which is an initial position of the male housing 10, into the accommodating portion 11 in a state in which the arc-shaped protrusions 32 are spread apart from each other by the upper rails 51 and the lower rails 55.

Here, upper and lower portions of the arc portions 33 of the arc-shaped protrusions 32 seated on the accommodating portion 11 are respectively supported by the upper rails 51 and the lower rails 55.

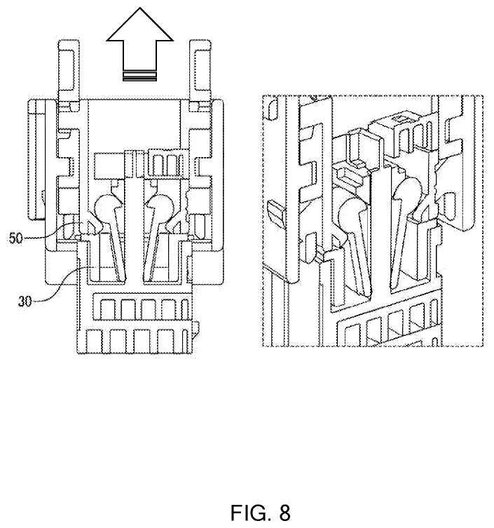

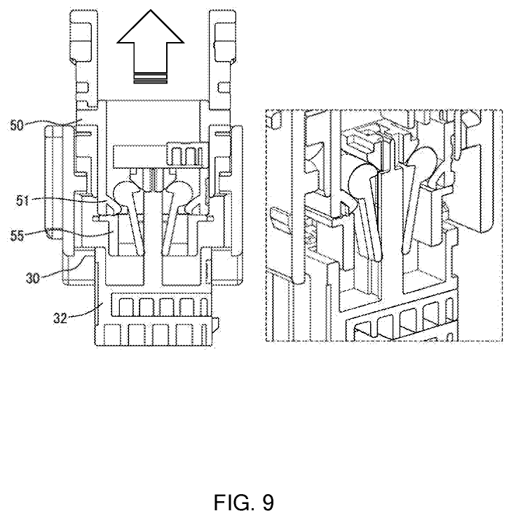

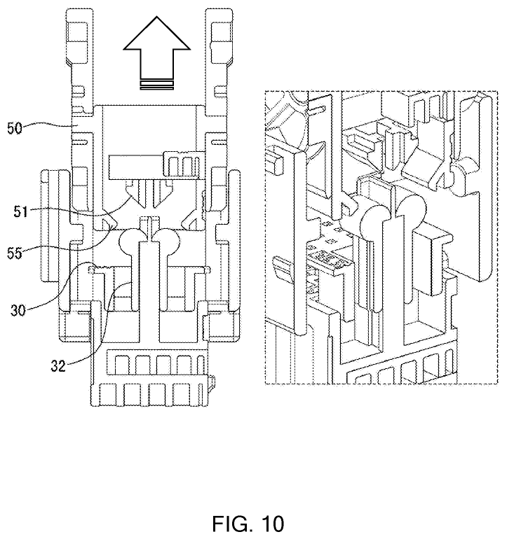

On the other hand, as illustrated in FIGS. 8 to 10, when the female connector 2 is separated from the male connector 1, the female housing 50 is moved in an upward direction, and the moving plate 30 is also moved in the upward direction by the arc portions 33 supported by the upper rails 51 and the lower rails 55.

Thereafter, at a position at which an end of the vertical extension portion 12 meets the inner stepped portions 36, the arc-shaped protrusions 32 are elastically coupled to an outer surface of the vertical extension portion 12 by elastic force, are separated from the lower rails 55, and the moving plate 30 is seated at the initial position.

Thereafter, only the female housing 50 is moved in the upward direction, so that the female connector 2 is separated from the male connector 1.

The connector assembly according to an embodiment of the present disclosure has the effect of preventing the moving plate from being released due to characteristics of the internal coupling structure.

Also, since the connector assembly according to an embodiment of the present disclosure is configured such that the moving plate does not surround the female connector, the size of the male connector may be reduced, and the space between the male connector and the female connector may be minimized, thereby the coupling of the connectors is easily performed.

Although the present disclosure has been illustrated and described with reference to specific preferred embodiments, the present disclosure is not limited thereto. It will be understood by those skilled in the art to which the present disclosure pertains that various modifications and variations may be made without departing from the technical spirit of the present disclosure as defined by the appended claims, and all such modifications and variations are intended to be included within the scope of the present disclosure.

1. A connector assembly comprising:
a female connector;
a male connector coupled to the female connector; and
a moving plate positioned in the male connector, the moving plate configured to move from a first position to a second position when the female connector is coupled to the male connector, and to move from the second position to the first position when the female connector is separated from the male connector.

2. The connector assembly of claim 1, wherein the male connector comprises a male housing in which the moving plate is positioned, and
the female connector comprises a female housing that is configured to be brought into contact with the moving plate.

3. The connector assembly of claim 2, wherein the moving plate comprises an arc-shaped protrusion that is configured to be brought into contact with the female housing.

4. The connector assembly of claim 2, wherein the male housing comprises a vertical extension portion to which the moving plate is coupled at the first position.

5. The connector assembly of claim 2, wherein the male housing comprises an accommodating portion in which the moving plate is positioned at the second position.

6. The connector assembly of claim 4, wherein the male housing comprises a center extension portion extending from an end of the vertical extension portion.

7. The connector assembly of claim 3, wherein the arc-shaped protrusion comprises a connection portion extending from a plate base and an arc portion positioned at an end of the connection portion.

8. The connector assembly of claim 3, wherein two arc-shaped protrusions are positioned symmetrically with respect to each other.

9. The connector assembly of claim 7, wherein the arc-shaped protrusion comprises an inner contact portion and an inner stepped portion, each of which is configured to be brought into contact with the male housing at the first position.

10. The connector assembly of claim 2, wherein the moving plate comprises a horizontal contact portion that is configured to be brought into contact with the female housing.

11. The connector assembly of claim 2, wherein the male housing comprises an accommodating portion in which the moving plate is positioned at the second position.

12. The connector assembly of claim 11, wherein the moving plate comprises a vertical guide that is configured to be brought into contact with a side wall of the accommodating portion.

13. The connector assembly of claim 2, wherein the moving plate comprises a horizontal contact portion that is configured to be brought into contact with the female housing.

14. The connector assembly of claim 7, wherein the female housing comprises an upper rail configured to press an upper portion of the arc portion, thereby rotating the arc-shaped protrusion.

15. The connector assembly of claim 7, wherein the female housing comprises a lower rail configured to support a lower portion of the arc portion.

16. The connector assembly of claim 2, wherein the male connector further comprises a male terminal position assurance (TPA) coupled to the male housing.

17. The connector assembly of claim 2, wherein the female connector further comprises a female TPA coupled to the female housing.

18. The connector assembly of claim 2, wherein the female connector further comprises a lever coupled to the female housing.

19. The connector assembly of claim 2, wherein the male connector further comprises a plurality of male terminals coupled to the male housing.

20. The connector assembly of claim 2, wherein the female connector further comprises a plurality of female terminals coupled to the female housing.
